(19) United States
(12) Patent Application Publication
(10) Pub. No.: US 2025/0214401 A1
(43) Pub. Date: Jul. 3, 2025

(54) VEHICULAR DRIVER ASSIST SYSTEM WITH DYNAMIC DIMMING OF MIRRORS AND WINDOWS

(71) Applicant: Magna Mirrors of America, Inc., Holland, MI (US)

(72) Inventor: Michael J. Baur, Kentwood, MI (US)

(21) Appl. No.: 18/987,128

(22) Filed: Dec. 19, 2024

Related U.S. Application Data
(60) Provisional application No. 63/616,856, filed on Jan. 2, 2024.

(51) Int. Cl. B60J 3/04; B60R 1/00; B60R 1/04; B60R 1/08; B60R 16/023

(52) U.S. Cl. CPC B60J 3/04; B60R 1/001; B60R 1/04; B60R 1/088; B60R 16/023; B60R 2300/30

(57) ABSTRACT

A vehicular driving assist system includes an interior rearview mirror assembly having a mirror head adjustable about a mounting base. The mirror head accommodates an electrochromic mirror reflective element. An electrically dimmable window is disposed at the vehicle and is electrically operable to adjust visible light transmissivity of the electrically dimmable window. The vehicular driving assist system, based at least on processing sensor data captured by a light sensor, determines ambient light at the vehicle. The vehicular driving assist system, based at least on the determined ambient light, (i) adjusts light reflectivity of the electrochromic mirror reflective element and (ii) adjusts visible light transmissivity of the electrically dimmable window.

### CROSS REFERENCE TO RELATED APPLICATION

The present application claims the filing benefits of U.S. provisional application Ser. No. 63/616,856, filed Jan. 2, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicle equipped with one or more electrically dimmable windows, such as the windshield, the rear window or windscreen, driver-side windows, and passenger-side windows, includes a vehicular driver assist system that controls dimming of the one or more dimmable windows based on sensor inputs from one or more detectors or systems of the vehicle.

For example, a vehicular driver assist system includes an interior rearview mirror assembly including a mirror head adjustable about a mounting structure. The mounting structure is configured to mount the interior rearview mirror assembly at an interior portion of a cabin of a vehicle equipped with the vehicular driver assist system. The mirror head accommodates an electrochromic mirror reflective element, and the electrochromic mirror reflective element is electrically operable to adjust light transmissivity of the electrochromic mirror reflective element. An electrically dimmable window is disposed at the vehicle, and wherein the electrically dimmable window is electrically operable to adjust light transmissivity of the electrically dimmable window to adjust a level of visible light incident at the electrically dimmable window that passes through the electrically dimmable window. A sensor generates sensor data. An electronic control unit (ECU) includes electronic circuitry and associated software, and the electronic circuitry of the ECU includes a processor operable to process sensor data transferred to the ECU. The vehicular driver assist system, based at least on processing captured sensor data transferred to the ECU, determines a level of ambient light at the vehicle. The vehicular driver assist system, based at least on the determined level of ambient light, (i) electrically operates the electrochromic mirror reflective element to adjust dimming of the electrochromic mirror reflective element and (ii) electrically operates the electrically dimmable window to adjust light transmissivity of the electrically dimmable window.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle equipped with a driver assist system and one or more electrically dimmable windows or glass panels;

FIG. 2 is a perspective view of an interior rearview mirror assembly of the vehicle; and

FIG. 3 is a perspective view of the vehicle, showing example dimming levels of the electrically dimmable windows.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and may provide an output to a display device for displaying images representative of the captured image data. Optionally, the vision system may provide display, such as a rearview display or a top down or bird's eye or surround view display or the like. As discussed further below, the vehicular driver assist system dynamically controls dimming of one or more electrically dimmable windows or glass panels at the vehicle, such as to reduce light transmissivity of the windows during daytime driving conditions and to increase light transmissivity of the windows during nighttime driving conditions. The dimmable window assembly may, for example, utilize aspects of the window assemblies described in U.S. Pat. Nos. 8,294,975; 7,543,947; 6,420,036; 6,002,511; 6,001,486; 5,910,854; 5,724,187; 5,500,760; 5,239,405; 5,233,461; 5,151,816; 5,145,609 and/or 5,140,455, and/or U.S. Publication No. US-2021-0114439, which are all hereby incorporated herein by reference in their entireties.

While fixed tinting of vehicular window glass with film reduces heat load from sun in sun rich environments, and may provide an aesthetic feature preferred by many drivers, a fixed film tint is not widely legally accepted in many jurisdictions. For example, the fixed tint provides low visibility at night, creating unsafe conditions to drive, and some jurisdictions have created laws to limit tinting in at least front side windows for this reason. Further, fixed tint reduces ability of law enforcement and others to ascertain conditions of the vehicle and its occupants when approaching the vehicle from the exterior. As discussed further below, electrically dimmable windows in conjunction with one or more sensors and vision systems at the vehicle may enhance functionality of dimmable windows, legal compliance of dimmed or tinted windows, and greater adoption of dimmable windows.

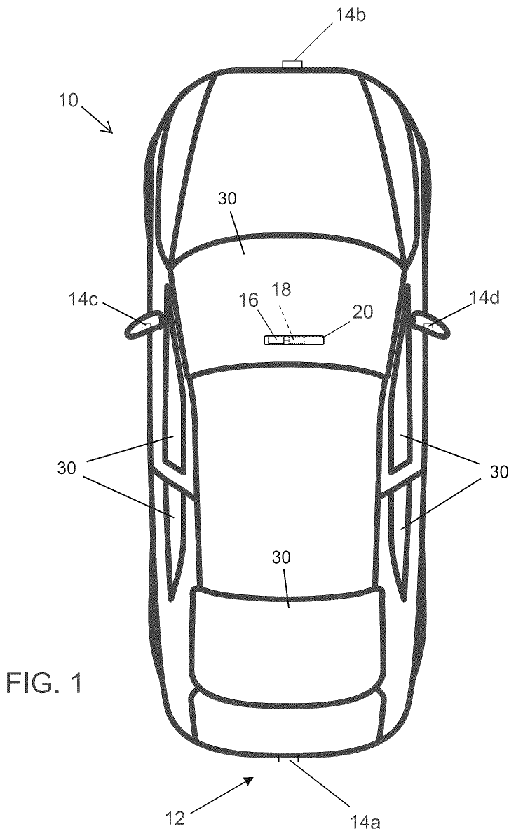

Referring now to the drawings and the illustrative embodiments depicted therein, a vehicle 10 includes a vehicular control system or driving assist system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

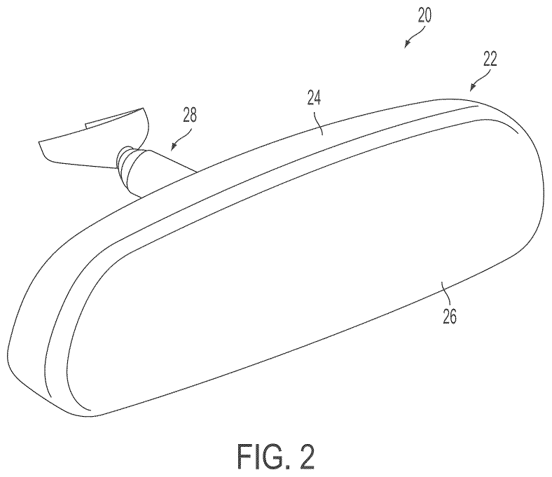

As shown in FIG. 2, the vehicular interior rearview mirror assembly 20 includes a mirror head 22 that includes a casing 24 and a reflective element 26 positioned at a front portion of the casing 24. In the illustrated embodiment, the mirror assembly 20 is configured to be adjustably mounted to the interior portion of the vehicle 10 (such as to an interior or in-cabin surface of a vehicle windshield or a headliner of a vehicle or the like) via a mounting structure or mounting configuration or assembly 28. The mirror reflective element 26 includes a variable reflectance mirror reflective element that varies its reflectance responsive to electrical current applied to conductive coatings or layers of the reflective element.

That is, the mirror reflective element 26 includes an electrochromic mirror reflective element that is dimmable responsive to an electric current applied to the electrochromic medium of the mirror reflective element. The mirror assembly 20 may provide an auto-dimming mirror reflective element that is dimmed based on detected levels of ambient light at the vehicle and/or detected glare light (e.g., emanating from headlamps of a trailing vehicle) incident at the mirror reflective element to improve visibility of the mirror reflective element and reduce intensity of reflected lights that may reflect toward the eyes of the driver. For example, an ambient light sensor may be disposed at the mirror assembly 20 for detecting ambient light levels within the cabin of the vehicle, such as within the mirror head and sensing ambient light at an aperture formed through the mirror casing. As discussed further below, a driver monitoring camera may be disposed at the mirror head, such as behind and viewing through the mirror reflective element, and image data captured by the driver monitoring camera may be processed for determining ambient light levels within the cabin of the vehicle and/or for detecting glare light incident at the mirror reflective element. Optionally, sensor data and/or image data captured by one or more sensors at the vehicle (e.g., the forward viewing camera, the rearward viewing camera, and the like) may be processed for determining ambient light levels at the vehicle and/or for detecting glare light incident at the mirror reflective element.

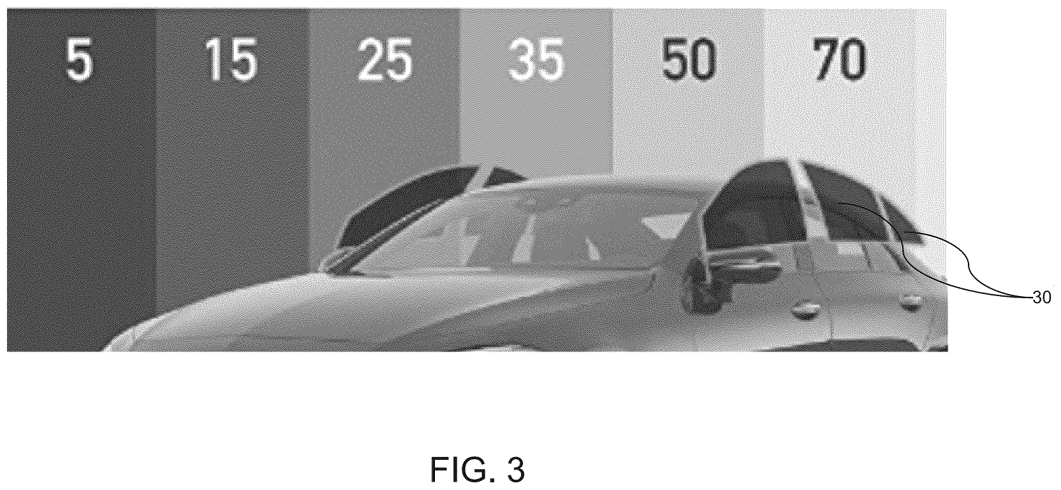

Referring to FIGS. 1 and 3, the vehicle 10 includes one or more electrically dimmable windows or glass panels 30, such as the driver-side and passenger-side front door window, rear door window, front door quarter window, rear door quarter window, vent windows, the windshield, the rear window or liftgate window, a sunroof/moonroof or glass roof panel, and the like. That is, the one or more dimmable windows 30 at the vehicle 10 are electrically operable to adjust light transmissivity of the windows and thus adjust the amount of light incident at the windows that is able to pass through the windows. For example, the electrically dimmable windows 30 may include an electrochromic (EC) medium or a layer of liquid crystal (LC) encapsulated in a polymer matrix and sandwiched between glass panels, where electric current applied to the dimmable window adjusts light transmissivity of the windows 30.

Each dimmable window 30 may be controlled to dynamically adjust light transmissivity through the window 30. For example, the dimmable windows 30 may be controlled between 100 percent transmissivity, where 100 percent of visible light incident at the window 30 passes through the window 30 and the window appears completely transparent, and 70 percent transmissivity or less, 50 percent transmissivity or less, 35 percent transmissivity or less, 25 percent transmissivity or less, 15 percent transmissivity or less, 5 percent transmissivity or less, and the like. At reduced transmissivity levels, a smaller portion of visible light incident at the window 30 passes through to reduce ambient light levels within the cabin of the vehicle and to reduce viewing ability into the cabin from exterior the vehicle. Further, dimming of the windows 30 may adjust the level of infrared or near infrared light that transmits through the windows 30, where a lower level of near infrared light transmittance may reduce heat transmittance into the vehicle cabin. Each dimmable window 30 may be dimmed in its entirety, where the light transmissivity is substantially constant across the window, or the dimmable window 30 may be locally dimmable, where respective regions or portions of the window 30 may be dimmed to different degrees compared to the rest of the window 30.

The system 12 controls dimming of the electrically dimmable windows 30 based on processing of sensor data captured by one or more sensors at the vehicle and/or inputs from one or more systems at the vehicle 10. For example, the system 12 determines ambient light levels within the vehicle cabin and/or the system 12 determines ambient light levels exterior the vehicle, such as based on processing of image data captured by the one or more exterior viewing cameras at the vehicle. Further, the system 12 may process image data captured by the one or more cameras at the vehicle to determine location of light sources (e.g., headlights from other vehicles behind the equipped vehicle or headlights from oncoming traffic, street lights, the sun, and the like) relative to the vehicle. Moreover, the system 12 may receive sensor data and/or inputs from an automatic headlight control system, an automatic windshield wiper system, a turn signal indicator, a blind zone indicator or monitoring system, a gear selector, among other vehicle systems. Thus, and as described further below, the system 12 may dynamically adjust dimming of the windows 30 based on a comprehensive set of inputs and captured sensor data to provide optimum window tinting or dimming for the vehicle.

The system 12 may control dimming of the electrically dimmable windows 30 based on detected levels of ambient light exterior and/or interior the vehicle 10. For example, when detected levels of ambient light exterior the vehicle are relatively high (e.g., during sunny daytime driving conditions), the system 12 may increase dimming of the windows 30 (i.e., decrease light transmissivity and thus darken the windows) to reduce the amount of light that passes through the windows 30 into the cabin of the vehicle 10. This may reduce thermal load from the sun in sunny conditions. When detected levels of ambient light exterior the vehicle are relatively low (e.g., during nighttime or overcast driving conditions), the system may decrease dimming of the windows 30 (i.e., increase light transmissivity and thus reduce darkening of the windows) to increase the amount of light that passes through the windows 30 into the cabin of the vehicle 10. This may increase visibility for the driver during darker driving conditions. In some examples, the system 12 may adjust dimming of the dimmable windows 30 based on ambient light levels within the cabin of the vehicle, such as to maintain a threshold level of ambient light within the vehicle.

In some examples, the system 12 may control dimming of the dimmable windows 30 based on a user input, such as to allow the driver to set a preferred level of dimming. For example, the driver may increase the level of dimming to increase privacy in the vehicle cabin or reduce the level of dimming to improve visibility through the windows 30. This may be controlled dynamically, where the driver can set the desired level of dimming, or based on modes, where the driver may adjust the windows between a daytime mode (with higher levels of dimming and thus lower levels of light transmissivity) and a nighttime mode (with lower levels of dimming or no dimming and thus higher levels of light transmissivity). Further, multiple windows 30, such as each window of the vehicle, may be dimmed collectively, or each window 30 may be individually dimmable, such that some windows 30 may be dimmed to a greater degree than other windows 30. For example, the windshield may be dimmed to a lesser degree than rear windows to maintain greater visibility through the windshield for the driver of the vehicle.

Because the system 12 may control dimming of the windows 30 and dimming of the electrically dimmable mirror reflective element 26, the system 12 may adjust dimming of the windows 30 based on detected glare light at the mirror reflective element 26. For example, based on detected glare light at the mirror reflective element 26, the system 12 may increase dimming of the rear window and thus reduce the amount of light passing through the rear window that is incident at the mirror reflective element. Further, based on captured sensor data (e.g., image data captured by a rearward viewing camera at the vehicle), the system may determine a relative position of the light source causing the glare light at the mirror reflective element and adjust dimming of one or more windows through which the light is directed. For example, if the system determines that the light source (e.g., headlights of a trailing vehicle) is behind the vehicle and in an adjacent lane, and thus the light passes through the rear window and at least one of the side windows, the system may increase dimming of the rear window and the at least one side windows to decrease the light transmissivity of the rear window and the side window and thus reduce the glare light at the mirror reflective element. Based on captured sensor data (e.g., image data captured by the driver monitoring camera at the mirror head), the system 12 may determine a relative position of the light source relative to the mirror reflective element 26 and/or a vector or trajectory of the light between the light source and the mirror reflective element, thus allowing the system to determine an intersection between the light and the one or more windows 30 of the vehicle. Accordingly, the system 12 may locally dim portions of the windows 30 at or near the intersection of the light source and the windows to reduce glare light at the mirror reflective element 26 without dimming the entirety of the window. This may reduce or eliminate the need to dim the mirror reflective element 26, leading to improved visibility at the mirror reflective element in glare light conditions.

Similarly, the system 12 may determine presence of glare light at one or more exterior rearview mirrors of the vehicle (e.g., based on captured image data or based on glare light sensors at the exterior rearview mirrors) and adjust dimming of the corresponding side windows based on the detected glare light, such as to locally dim portions of the side windows based on where the reflected light would be directed from the exterior rearview mirrors toward the eyes of the driver. Thus, the side view window may be dimmed to reduce glare light reflected from the exterior rearview mirrors and entering the vehicle. This may reduce or eliminate the need to dim the reflective elements of the exterior rearview mirrors.

Optionally, the system 12 may dim the windshield based on detection of headlights or other light sources ahead of the vehicle, such as from oncoming traffic. For example, based on image data captured by the forward viewing camera of the vehicle (e.g., a camera mounted at the in-cabin surface of the windshield and viewing forward of the vehicle), the system may determine intersection of the light directed from the oncoming vehicle's headlights with the equipped vehicle's windshield and locally dim the windshield at or near or including the intersected portion of the windshield.

In some examples, the system 12 determines that a turn signal of the vehicle is activated and the system 12 may reduce dimming of the windows at the side of the vehicle corresponding to the activated turn signal. For example, based on activation of a driver-side turn signal indicator, the system may reduce dimming of the windows 30 at the driver side of the vehicle to increase visibility for the driver in the direction in which they are turning or changing lanes. Similarly, the dimming of the windows may be adjusted based on a rotational angle of the steering wheel, such as to reduce dimming of windows at a side of the vehicle corresponding to the turning direction of the steering wheel. Optionally, the system may reduce dimming of the windows based on the steering wheel being rotated more than a threshold amount (e.g., by 10 degrees or more, by 30 degrees or more, by 45 degrees or more, by 90 degrees or more and the like), such as that dimming may be adjusted when the vehicle is making a turn but not when the vehicle is changing lanes or following a curve in the road.

Further, the system 12 may adjust dimming of the windows based on signals from a blind zone indicator or warning system. When another vehicle or obstacle is detected along the side of the vehicle, and/or in a blind zone of the vehicle, the system may generate an alert for the driver (e.g., illuminate an icon at the exterior rearview mirror and/or play an audio tone) and the system may reduce dimming of the windows at the side of the vehicle corresponding to the detected other vehicle.

Based on a gear selector or propulsion system of the vehicle being adjusted to a reverse gear or reverse, the dimming of the rear window may be reduced to improve visibility through the rear window. Similarly, when the gear selector is adjusted to a parking gear or a drive gear, the dimming of the rear window may be increased.

To ensure that the system 12 is compliant with local regulations, the system 12 may determine global position of the vehicle 10 based on signals from a global positioning system (GPS) of the vehicle and adjust dimming of the windows 30 based on the current position of the vehicle 10. For example, some jurisdictions may allow dimming of rear windows and not allow dimming of front windows or the windshield of the vehicle. Further, jurisdictions may set maximum limits for dimming (or minimum level of light transmissivity) of one or more windows of the vehicle, such as a minimum level of light transmissivity for the windshield of 70 percent. Accordingly, the system may set a maximum threshold level of dimming and/or a minimum threshold level of light transmissivity for each window 30 based on the current position of the vehicle, where the threshold level of dimming and/or threshold level of light transmissivity is configured to satisfy requirements of the associated jurisdictions.

In some examples, the system 12 may set the maximum threshold level of dimming and/or the minimum threshold of light transmissivity for each window based on a driving condition of the vehicle, such as a weather condition, daytime or nighttime condition, presence of the vehicle on a highway, a residential road, or a country road, and the like. For example, the system 12 may set higher maximum threshold levels of dimming (and thus allow greater levels of dimming) during clear weather conditions, daytime driving conditions, and presence of the vehicle on a highway and the system may set lower maximum threshold levels of dimming (and thus allow less dimming) during rainy or snowy weather conditions, nighttime driving conditions, and presence of the vehicle on a residential or country road.

Further, the system 12 may, responsive to a signal from an external or remote device, reduce or eliminate dimming at individual windows or each window 30 simultaneously. For example, the signal may be received from a radio frequency (RF) transmitter or other transmitter associated with law enforcement approaching the vehicle to improve visibility into the vehicle cabin. That is, the system may be equipped with an “all clear” signal enabled by RF or other means to eliminate the dimming on all vehicle windows simultaneously or individually in order to enhance the interior visibility in certain situations.

One or more of the windows 30 may have a baseline or permanent tint, such as a darkened film applied at an outer surface of the window 30. Thus, the system may provide enhanced tinting of moderately tinted windows and, if the system experiences a failure, a baseline level of tinting remains at the windows. Further, the system may be configured to, in the event of a power disconnect or other failure, return to a baseline dimming level, such as a non-tinted state, to maintain visibility during system failure.

Thus, dimming of the vehicle windows can be adjusted by monitoring light conditions monitored for the electrochromic dimming of the mirror reflective element. Various light sensing systems, including electrochromic functionality built into cameras at the vehicle, dimming can be adjusted based on ambient light conditions at the vehicle. Together with other inputs (including headlights, windshield wipers, turn signals, blind zone indicator systems, reverse lights, and the like), the system may dynamically determine optimum solutions for the window tinting or dimming of the entire vehicle.

In addition to the tinting or dimming of the windows, the system may selectively activate the dimming in restricted areas of the window in order to mitigate headlight glare at night, such as at a driver side portion of the windshield and/or regions of the side windows corresponding to the exterior rearview mirrors. Dimming of the vehicle windows may be implemented as an alternative or an enhancement of electrochromic dimming exterior mirrors. The selectively dimming area of the windows can be managed by the driver of the electrochromic mirrors to maximize system efficacy.

The windows may include any suitable electrically operable dimming technology, such as electrochromic (EC) and liquid crystal (LC). The windows may include a cellular structure between two substrates of glass. Further, the windows may include a film applied singularly to a piece of glass, and/or a film that is laminated between two pieces of glass in a cellular fashion.

The electrically dimmable windows may include characteristics of the systems described in U.S. Pat. Nos. 11,840,174; 8,610,992 and/or 6,045,724 and/or U.S. Publication No. US-2021-0114439, which are hereby incorporated herein by reference in their entireties.

The electrochromic mirror element of the electrochromic mirror assembly and/or the dimmable window assemblies may utilize aspects of the mirror assemblies and systems described in U.S. Pat. Nos. 8,503,061; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, which is hereby incorporated herein by reference in its entirety.

The mirror assembly may include a camera or sensor or light of a driver monitoring system and/or head and face direction and position tracking system and/or eye tracking system and/or gesture recognition system. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. provisional application Ser. No. 63/727,720, filed Dec. 4, 2024, and/or U.S. provisional application Ser. No. 63/651,537, filed May 24, 2024, and/or International Publication No. WO 2023/220222, which are hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from a forward or outward viewing camera, as well as from a rearward viewing camera and sideward viewing cameras of the CMS, to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0155167 and/or US-2019-0118717, which are all hereby incorporated herein by reference in their entireties.

The camera (e.g., the DMS camera) may be used to detect ambient light and/or glare light (emanating from headlamps of a trailing vehicle) for use in providing auto-dimming of the EC mirror reflective element. The DMS camera may be disposed in the mirror head and viewing rearward through the mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Publication Nos. US-2024-0064274; US-2019-0258131 and/or US-2019-0047475, which are all hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments may be carried out without departing from the principles of the present invention, which is intended to be limited only by the scope of the appended claims as interpreted according to the principles of patent law.

1. A vehicular driving assist system, the vehicular driving assist system comprising:
an interior rearview mirror assembly comprising a mirror head adjustable about a mounting base, wherein the mounting base is configured to mount the interior rearview mirror assembly at an interior portion of an interior cabin of a vehicle;
wherein the mirror head accommodates an electrochromic mirror reflective element, and wherein the electrochromic mirror reflective element is electrically operable to adjust light reflectivity of the electrochromic mirror reflective element;
wherein an electrically dimmable window is disposed at the vehicle, and wherein the electrically dimmable window is electrically operable to adjust visible light transmissivity of the electrically dimmable window;
a light sensor that captures sensor data;
an electronic control unit (ECU) comprising electronic circuitry and associated software, wherein the electronic circuitry comprises a processor operable to process sensor data captured by the light sensor;
wherein sensor data captured by the light sensor is transferred to and is processed at the ECU;
wherein the vehicular driving assist system, based at least on processing at the ECU of sensor data captured by the light sensor and transferred to the ECU, determines ambient light at the vehicle; and
wherein the vehicular driving assist system, based at least in part on the determined ambient light, (i) adjusts light reflectivity of the electrochromic mirror reflective element and (ii) adjusts visible light transmissivity of the electrically dimmable window.

2. The vehicular driving assist system of claim 1, wherein the electrically dimmable window comprises one selected from the group consisting of (i) a windshield of the vehicle, (ii) a rear window of the vehicle, (iii) a driver-side window of the vehicle and (iv) a passenger-side window of the vehicle.

3. The vehicular driving assist system of claim 1, wherein the electrically dimmable window comprises a plurality of electrically dimmable windows, and wherein the plurality of electrically dimmable windows includes (i) a rear window of the vehicle, (ii) a driver-side window of the vehicle and (iii) a passenger-side window of the vehicle.

4. The vehicular driving assist system of claim 3, wherein the vehicular driving assist system adjusts, independently from one another, visible light transmissivity of (i) the rear window of the vehicle, (ii) the driver-side window of the vehicle and (iii) the passenger-side window of the vehicle.

5. The vehicular driving assist system of claim 4, wherein the light sensor comprises a camera, and wherein the vehicular driving assist system adjusts visible light transmissivity of individual ones of the plurality of electrically dimmable windows differently from one another based on a determined location of a light source within a field of view of the camera.

6. The vehicular driving assist system of claim 3, wherein the vehicular driving assist system locally adjusts visible light transmissivity of a portion of at least one electrically dimmable window of the plurality of electrically dimmable windows.

7. The vehicular driving assist system of claim 6, wherein the light sensor comprises a camera, and wherein the vehicular driving assist system locally adjusts visible light transmissivity of the portion of the at least one electrically dimmable window of the plurality of electrically dimmable windows based on a determined location of a light source within a field of view of the camera.

8. The vehicular driving assist system of claim 1, wherein the vehicular driving assist system adjusts visible light transmissivity of the electrically dimmable window between at least (i) a daytime driving mode where a first level of visible light incident at the electrically dimmable window passes through the electrically dimmable window and (ii) a nighttime driving mode where a second level of visible light incident at the electrically dimmable window passes through the electrically dimmable window, and wherein the second level of visible light is greater than the first level of visible light.

9. The vehicular driving assist system of claim 1, wherein the vehicular driving assist system adjusts visible light transmissivity of the electrically dimmable window to maintain at least a threshold transmissivity of visible light passing through the electrically dimmable window.

10. The vehicular driving assist system of claim 9, wherein the threshold transmissivity of visible light passing through the electrically dimmable window is based at least in part on a determined geographic location of the vehicle.

11. The vehicular driving assist system of claim 9, wherein the threshold transmissivity of visible light passing through the electrically dimmable window is based at least in part on a position of the electrically dimmable window at the vehicle.

12. The vehicular driving assist system of claim 9, wherein the threshold transmissivity of visible light passing through the electrically dimmable window is based at least in part on a determined condition at the vehicle.

13. The vehicular driving assist system of claim 12, wherein the determined condition comprises at least one selected from the group consisting of (i) a weather condition, (ii) a road condition and (iii) a time condition.

14. The vehicular driving assist system of claim 1, wherein the vehicular driving assist system, responsive to detection of glare light incident at the electrochromic mirror reflective element, adjusts visible light transmissivity of the electrically dimmable window to reduce visible light transmissivity of the electrically dimmable window.

15. The vehicular driving assist system of claim 1, wherein the electrically dimmable window comprises an electrochromic medium disposed between a first glass substrate and a second glass substrate.

16. The vehicular driving assist system of claim 1, wherein the electrically dimmable window comprises a liquid crystal medium disposed between a first glass substrate and a second glass substrate.

17. The vehicular driving assist system of claim 1, wherein the light sensor comprises at least one photosensing element.

18. The vehicular driving assist system of claim 1, wherein the light sensor comprises a camera.

19. A vehicular driving assist system, the vehicular driving assist system comprising:
an interior rearview mirror assembly comprising a mirror head adjustable about a mounting base, wherein the mounting base is configured to mount the interior rearview mirror assembly at an interior portion of an interior cabin of a vehicle;
wherein the mirror head accommodates an electrochromic mirror reflective element, and wherein the electrochromic mirror reflective element is electrically operable to adjust light reflectivity of the electrochromic mirror reflective element;
wherein an electrically dimmable window is disposed at the vehicle, and wherein the electrically dimmable window is electrically operable to adjust visible light transmissivity of the electrically dimmable window;
a camera that captures image data;
an electronic control unit (ECU) comprising electronic circuitry and associated software, wherein the electronic circuitry comprises an image processor operable to process image data captured by the camera;
wherein image data captured by the camera is transferred to and is processed at the ECU;
wherein the vehicular driving assist system, based at least on processing at the ECU of image data captured by the camera and transferred to the ECU, determines ambient light at the vehicle;
wherein the vehicular driving assist system, based at least in part on the determined ambient light, (i) adjusts light reflectivity of the electrochromic mirror reflective element and (ii) adjusts visible light transmissivity of the electrically dimmable window;
wherein the vehicular driving assist system locally adjusts visible light transmissivity of a portion of the electrically dimmable window based on a determined location of a light source within a field of view of the camera; and
wherein the vehicular driving assist system adjusts visible light transmissivity of the electrically dimmable window to maintain at least a threshold transmissivity of visible light passing through the electrically dimmable window.

20. The vehicular driving assist system of claim 19, wherein the electrically dimmable window comprises one selected from the group consisting of (i) a windshield of the vehicle, (ii) a rear window of the vehicle, (iii) a driver-side window of the vehicle and (iv) a passenger-side window of the vehicle.

21. The vehicular driving assist system of claim 19, wherein the threshold transmissivity of visible light passing through the electrically dimmable window is based at least in part on a determined geographic location of the vehicle.

22. The vehicular driving assist system of claim 19, wherein the threshold transmissivity of visible light passing through the electrically dimmable window is based at least in part on a position of the electrically dimmable window at the vehicle.

23. The vehicular driving assist system of claim 19, wherein the vehicular driving assist system, responsive to detection of glare light incident at the electrochromic mirror reflective element, adjusts visible light transmissivity of the electrically dimmable window to reduce visible light transmissivity of the electrically dimmable window.

24. A vehicular driving assist system, the vehicular driving assist system comprising:
an interior rearview mirror assembly comprising a mirror head adjustable about a mounting base, wherein the mounting base is configured to mount the interior rearview mirror assembly at an interior portion of an interior cabin of a vehicle;
wherein the mirror head accommodates an electrochromic mirror reflective element, and wherein the electrochromic mirror reflective element is electrically operable to adjust light reflectivity of the electrochromic mirror reflective element;
wherein a plurality of electrically dimmable windows is disposed at the vehicle, and wherein each electrically dimmable window of the plurality of electrically dimmable windows is electrically operable to adjust visible light transmissivity of the electrically dimmable window;
a light sensor that captures sensor data;
an electronic control unit (ECU) comprising electronic circuitry and associated software, wherein the electronic circuitry comprises a processor operable to process sensor data captured by the light sensor;
wherein sensor data captured by the light sensor is transferred to and is processed at the ECU;
wherein the vehicular driving assist system, based at least on processing at the ECU of sensor data captured by the light sensor and transferred to the ECU, determines ambient light at the vehicle;
wherein the vehicular driving assist system, based at least in part on the determined ambient light, (i) adjusts light reflectivity of the electrochromic mirror reflective element and (ii) adjusts visible light transmissivity of the plurality of electrically dimmable windows; and
wherein the vehicular driving assist system adjusts visible light transmissivity of each electrically dimmable window of the plurality of electrically dimmable windows between at least (i) a daytime driving mode where a first level of visible light incident at the electrically dimmable window passes through the electrically dimmable window and (ii) a nighttime driving mode where a second level of visible light incident at the electrically dimmable window passes through the electrically dimmable window, and wherein the second level of visible light is greater than the first level of visible light.

25. The vehicular driving assist system of claim 24, wherein the plurality of electrically dimmable windows includes (i) a rear window of the vehicle, (ii) a driver-side window of the vehicle and (iii) a passenger-side window of the vehicle.

26. The vehicular driving assist system of claim 25, wherein the vehicular driving assist system adjusts, independently from one another, visible light transmissivity of (i) the rear window of the vehicle, (ii) the driver-side window of the vehicle and (iii) the passenger-side window of the vehicle.

27. The vehicular driving assist system of claim 26, wherein the light sensor comprises a camera, and wherein the vehicular driving assist system adjusts visible light transmissivity of individual ones of the plurality of electrically dimmable windows differently from one another based on a determined location of a light source within a field of view of the camera.
